(19) United States
(12) Patent Application Publication
(10) Pub. No.: US 2006/0231362 A1
(43) Pub. Date: Oct. 19, 2006

(54) Hydraulic shock absorber

(76) Inventor: Ching-Chuan Yang, Taipei County (TW)

Correspondence Address: BIRCH STEWART KOLASCH & BIRCH, PO BOX 747, FALLS CHURCH, VA, 22040-0747, US

(21) Appl. No.: 11/318,498

(22) Filed: Dec. 28, 2005

(30) Foreign Application Priority Data
Apr. 18, 2005 (TW) 094206007

(51) Int. Cl. F16F 9/50

(52) U.S. Cl. 188/322.22; 188/322.15; 188/282.1

(57) ABSTRACT

A hydraulic shock absorber comprises a pipe body, a piston rod, a ring, a piston, and a hydraulic oil contained in the pipe body. The ring is coupled to a tapered portion of the piston rod and moved along an aslant tapered surface of the tapered portion, and the piston is fixed to a connecting portion of the piston rod and can move together with the piston rod. The piston has a longitudinally penetrating through hole that restricts the hydraulic oil to pass the piston through the through hole only. If the piston rod is pulled, the ring will move along the tapered portion and attach on the surface of the piston to block a portion of the through hole, and the piston rod moves slowly to produce a shock absorbing force, so as to achieve the purpose of reducing shocks and noises during the movement of an object.

### FIELD OF THE INVENTION

The present invention relates to a shock absorber, and more particularly to a hydraulic shock absorber that uses a hydraulic oil as a medium.

### BACKGROUND OF THE INVENTION

Shock absorber is used for absorbing shocks and noises produced when an object is collided, and generally installed between a doorframe and a door panel or in a high-speed operating automated machine. In early days, a plastic pad and a spring are used extensively as shock absorbers. Although the force produced by an object can be retarded, a strong resisting force will be produced after the retardation, and thus the kinetic energy produced by the object cannot be absorbed, and the resisting force causes an inefficient shock absorbing effect. Therefore, air pressure shock absorbers and hydraulic shock absorbers are used extensively for converting the kinetic energy of a moving object into heat energy by gas or oil and then releasing the heat energy. The shock absorbers of this sort can smoothly stop the movement of the object and greatly reduce the shocks and noises produced during the movement of the object.

Referring to FIG. 1 for the structure of a prior art hydraulic shock absorber, the prior art hydraulic shock absorber comprises a pipe body 100, a piston 110, a piston rod 120, a bearing 130, an oil seal 140, an oil seal receiver 150, and a hydraulic oil 160. An O-ring 111 is embedded into an external wall of the piston 110, and a penetrating rod hole 112 is disposed at the center of the piston 110 for passing the piston rod 120 through, and a groove 113 and a diversion groove 114 are disposed on both sides of the penetrating rod hole 112, a first diversion hole 115 and a second diversion hole 115 are disposed at the bottoms of the groove 113 and the diversion groove 114 respectively, and the groove 113 is provided for accommodating a steel ball 117.

When the piston 110 moves upward, the hydraulic oil 160 pushes the steel ball 117 to move towards the bottom of the groove 113 and block the first diversion hole 115. The hydraulic oil 160 above the piston 110 flows through the second diversion hole 116 to the bottom of the piston 110, such that the piston rod 120 moves slowly to provide a shock absorbing force. When the piston 110 moves downward, the hydraulic oil 160 pushes the steel ball 117 to be separated from the bottom of the groove 113, and the hydraulic oil 160 under the piston 110 flows through the first diversion hole 115 and the second diversion hole 116 to the top of the piston 110, such that the piston rod 120 can move easily.

However, the prior art hydraulic shock absorber uses a steel ball 117 to block or not to block the first diversion hole 115 to control the speed of the movement of the piston rod 120 and provide the shock absorbing force. The existing problem of this prior art resides on that the surface of the steel ball 117 or the connecting surface of the first diversion hole 115 and the steel ball 117 may be uneven after they are manufactured, and thus the steel ball 117 cannot block the first diversion hole 115 completely. As a result, there will be a leak of hydraulic oil 160 as well as a drop of efficiency of the hydraulic shock absorber.

### SUMMARY OF THE INVENTION

The primary objective of the present invention is provide a hydraulic shock absorber capable of absorbing the shocks and noises produced when an object is collided.

To achieve the foregoing objective, a hydraulic shock absorber in accordance with a preferred embodiment of the present invention comprises a pipe body, a piston rod, a ring, a piston, and a hydraulic oil contained in the pipe body. A pulling portion of the piston rod includes a cover body and at least one sealing member, and a ring is sheathed onto the tapered portion of the piston rod and moved according to the tapered slanting surface of a tapered portion. The piston is coupled to a connecting portion at the rear end of the piston rod, so that the piston can move together with the piston rod. The piston separates a hollow portion of a pipe body into a first space proximate to an open end and a second space proximate to a closed end, and the piston includes a circular groove for connecting a gasket, and the piston includes a longitudinally penetrating through hole, such that the hydraulic oil in the pipe body can pass through the piston via the through hole. If the ring is moved to an end of the piston close to the tapered portion and attached onto the surface of the piston, then a portion of the through hole will be blocked.

If the piston rod is pushed, the ring will move away from the through hole, such that the hydraulic oil can pass through the through hole and flow from the second space to the first space, and the piston rod can be moved easily. On the other hand, if the piston rod is pulled to drive the piston to move and compress the first space, the ring will move along the tapered portion and attach onto the surface of the piston to block a portion of the through hole. Therefore, the piston rod will move slowly and produce a shock absorbing force, so as to achieve the purpose of reducing shocks and noises produced when the object is moved.

### BRIEF DESCRIPTION OF THE DRAWINGS

FIG. 1 is a schematic view of the structure of a prior hydraulic shock absorber;

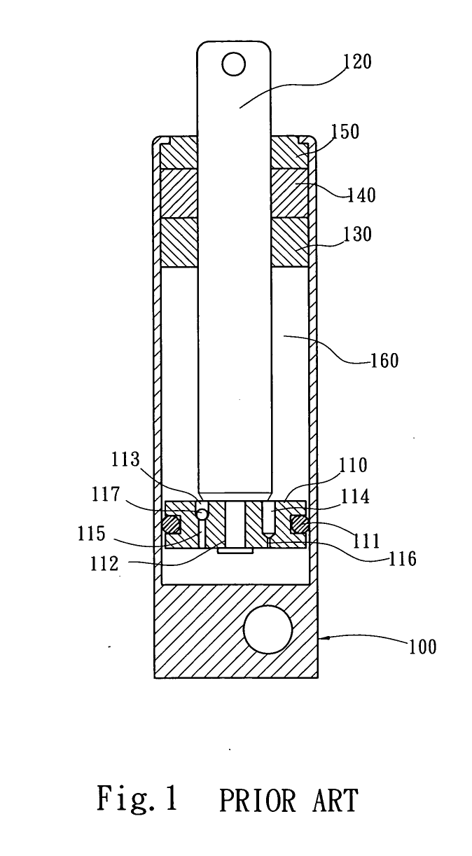

FIG. 2 is a schematic view of the structure of a hydraulic shock absorber according to a preferred embodiment of the invention;

FIG. 3 is a perspective view of the structure of a hydraulic shock absorber according to a preferred embodiment of the invention;

FIGS. 4A and 4B are schematic views of the movements of a hydraulic shock absorber according to a preferred embodiment of the invention; and

FIG. 5 is a schematic view of the movement of a hinge of a hydraulic shock absorber according to a preferred embodiment of the invention.

### DETAILED DESCRIPTION OF THE PREFERRED EMBODIMENTS

The technical contents of the present invention will now be described in more detail hereinafter with reference to the accompanying drawings as follows:

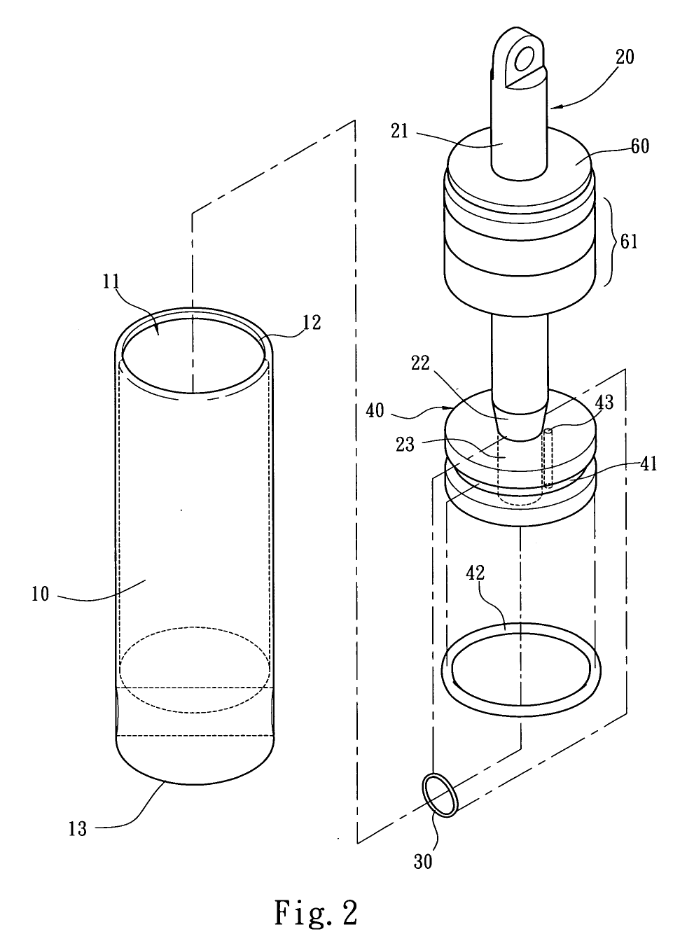

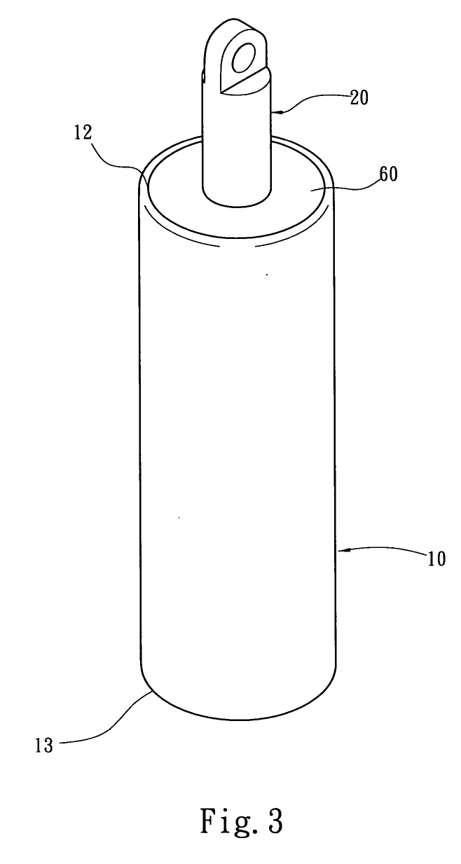

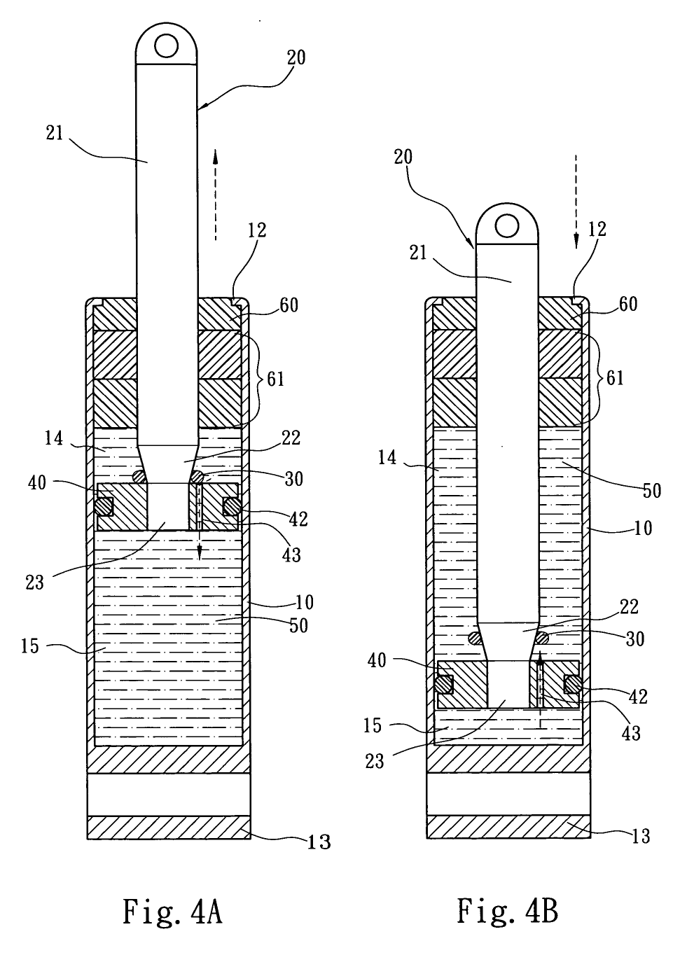

Referring to FIGS. 2 and 4A for the hydraulic shock absorber in accordance with a preferred embodiment of the present invention, the hydraulic shock absorber comprises a pipe body 10, a piston rod 20, a ring 30, a piston 40, and a hydraulic oil 50 contained in the pipe body 10. Referring to FIG. 3 for the perspective view of the hydraulic shock absorber of the invention, the pipe body 10 includes a hollow portion 11 for containing the hydraulic oil 50 and other components, and the pipe body 10 includes an open end 12 and a closed end 13 on both ends of the pipe body 10.

The piston rod 20 comprises a pulling portion 21, a tapered portion 22, and a connecting portion 23, wherein the pulling portion 21 includes a cover body 60 and at least one sealing member 61, and the cover body 60 and a sealing member 61 are coupled with each other, such that the piston rod 20 can be pulled or pushed vertically with respect to the cover body 60 and the sealing member 61, and the cover body 60 is fixed to the open end 12 of the pipe body 10. The tapered portion 22 is a structure tapered towards the piston 40, and the ring 30 is connected to the tapered portion 22 and moved along the aslant surface of the tapered portion 22, and the ring 30 could be made of a material including but not limited to a rubber material. The connecting portion 23 at the rear end of the piston rod 20 is fixed to a piston 40, and the piston rod 20 drives the piston 40 to move vertically up and down in the hollow portion 11 of the pipe body 10.

The foregoing sealing member 61 is used as an oil seal and made of an oil-resisting and wear-resisting material such as plastics or metals for preventing a leak of the hydraulic oil 50 in the pipe body 10. The number of installed sealing members 61 can be changed according to the user requirements and is not limited to those illustrated in the figures.

The piston 40 includes an inwardly concave circular groove 41, and a gasket 42 connected to the circular groove 41 and contacted with the internal wall of the pipe body 10. The gasket 42 of this preferred embodiment is an O-ring with an O-shape cross-section and made of a material including but not limited to a rubber material, and the gasket 42 is a compressive sealing member, so that the gasket 42 at the internal wall of the pipe body 10 can be compressed and deformed to achieve the sealing effect. The piston 40 further includes a longitudinally penetrating through hole 43, so that the hydraulic oil 50 in the pipe body 10 can pass through the piston 40 via the through hole 43 only. If the foregoing ring 30 is moved to an end of the tapered portion 22 proximate to the piston 40 and attached onto the surface of the piston 40 to block a portion of the through hole 43.

Referring to FIGS. 4A and 4B for the application of this preferred embodiment, the piston 40 divides the hollow portion 11 of the pipe body 10 into a first space 14 proximate to the open end 12 and a second space 15 proximate to the closed end 13. If users pull the piston rod 20 out from the pipe body 10 (as shown in FIG. 4A), the piston 40 compresses the hydraulic oil 50 in the first space 14 to produce a pressure to drive the ring 30 to move along an aslant surface of the tapered portion 22 and attach onto the surface of the piston 40. The ring 30 blocks a portion of the through hole 43, so that the hydraulic oil 50 can flow though the portion of unblocked through hole 43 only and flow from the first space 14 to the second space 15. Therefore, the piston rod 20 can be pulled slowly to produce a shock absorbing force and pull the piston rod 20 as well.

If users push the piston rod 20 towards the interior of the pipe body 10 (as shown in FIG. 4B), the piston 40 will compress the hydraulic oil 50 in the second space 15 to produce a pressure and drive the hydraulic oil 50 to pass through the through hole 43 and push the ring 30 of the originally blocked through hole 43, and the ring 30 moves along the aslant surface of the tapered portion 22 and in the direction away from the piston 40. Therefore, the through hole 43 is no longer blocked, and the hydraulic oil 50 can flow through the unblocked through hole 43 and from the second space 15 to the first space 14. Therefore, the piston rod 20 can be pushed into the pipe body 10 easily.

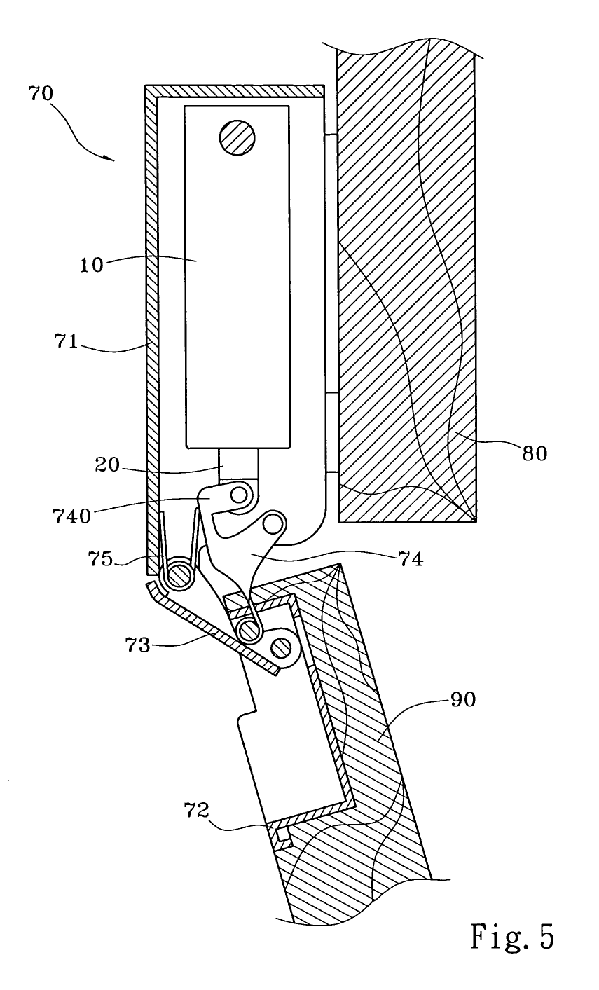

Referring to FIG. 5 for the hinge device 70 being used between a doorframe 80 and a door panel 90, the design of the hinge device 70 provides a torque, so that the doorframe 80 and the door panel 90 can be connected with each other and spread open with respect with each other. If the doorframe 80 and the door panel 90 are spread open to a specific position, the relative positions of the doorframe 80 and the door panel 90 will not be changed easily at will.

The hinge device 70 comprises a fixing member 71, a rotating member 72, a connecting member 73, a pressing member 74, and a resilient member 75, wherein the fixing member 71 and the rotating member 72 are installed at the edges of the doorframe 80 and the door panel 90, and a connecting member 73 is used to connect the fixing member 71 and the rotating member 72, and both ends of the pressing member 74 are pivotally coupled to the fixing member 71 and the rotating member 72, and a pivoting portion 740 is pivotally coupled to a piston rod 20 of the hydraulic shock absorber according to this preferred embodiment. Further, the resilient member 75 is disposed between the fixing member 71 and the connecting member 73 and pressed by the pressing member 74.

If the hinge device 70 is adopted in this preferred embodiment, the door panel 90 can be opened with respect to the doorframe 80 to drive the pressing member 74 to press against the resilient member 75. If the resilience of the resilient member 75 is overcome, the door panel 90 will be set to an open position, and the resilient member 75 will produce a resilience to return the pressing member 74 to a closed position. Now, a pivoting portion 740 of the pressing member 74 drives the piston rod 20 into the pipe body 10. Since the through hole 43 is not blocked by the ring 30, therefore the door panel 90 can be opened easily. If it is necessary to close the door panel 90, the pressing member 74 will drive the piston rod 20 out of the pipe body 10. Since a portion of the through hole 43 is blocked by the ring 30, therefore the hydraulic shock absorber can produce a shock absorbing force to drive the pressing member 74 to move the door panel 90 slowly to the close position. In the meantime, the pressing member 74 will not press against the resilient member 75 anymore, and the resilience of the resilient member 75 is released, such that the aforesaid shock absorbing force drives the door panel 90 close to the doorframe 80, and thus noises or shocks will not be produced when the door panel 90 is slammed onto the doorframe 80.

In the foregoing preferred embodiment, the installation position of the hinge device 70 is not limited to the position between the doorframe 80 and the door panel 90, but also could be used at a position between any two objects that will produce shocks and noises when the two objects are opened or closed with respect to each other. Further, the hydraulic shock absorber according to the preferred embodiment of the present invention is not used only for the hinge device 70, but also could be used for other high-speed operating automated machines.

In summation of the description above, the hydraulic shock absorber of the invention uses the ring 30 coupled to the tapered portion 22 of the piston rod 20 to connect the through hole 43 of the longitudinally penetrating piston 40. If a user presses the piston rod 20, the ring 30 will move away from the through hole 43, so that the piston rod 20 can be moved easily. On the other hand, if the piston rod 20 is pushed to drive the piston 40 to move and compress the first space 14, the ring 30 will be attached onto the surface of the piston 40 to block a portion of the through hole 43 and produce a shock absorbing force to move the piston rod 20, so as to achieve the purpose of reducing the shocks and noises produced during the movement of an object.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A hydraulic shock absorber, comprising:
a pipe body, having a hollow portion, and both ends of said pipe body are an open end and a closed end;
a piston rod, including a pulling portion, a tapered portion, and a connecting portion, and said pulling portion includes a cover body and at least one sealing member, and said cover body is fixed at said open end of said pipe body;
a ring, coupled onto said tapered portion;
a piston, fixed to said connecting portion of said piston rod, and having a circular groove and a gasket coupled to said circular groove, and said gasket is in contact with the internal wall of said pipe body to separate said hollow portion into a first space proximate to said open end and a second space proximate to said closed end, and said piston further includes a through hole longitudinally penetrating said piston; and
a hydraulic oil, contained in said hollow portion of said pipe body for pulling said piston rod out from said pipe body, such that said ring moves along said tapered portion to the surface of said piston and blocks a portion of said through hole, and said hydraulic oil flows slowly from said first space to said second space to produce a shock absorbing force, for pushing said piston rod into said hollow portion, such that said hydraulic oil in said second space flows through said through hole and pushes said ring to move along said tapered portion and away from said through hole, and said hydraulic oil flows quickly from said second space to said first space, so as to move said piston rod easily.

2. The hydraulic shock absorber of claim 1, wherein said gasket is made of a rubber material.

3. The hydraulic shock absorber of claim 1, wherein said ring is made of a rubber material.
